(19) United States
(12) Patent Application Publication
(10) Pub. No.: US 2007/0261523 A1
(43) Pub. Date: Nov. 15, 2007

(54) Adjustable food slicer

(76) Inventors: Lance Gordon Hussey, Simi Valley, CA (US); Craig Steele, Santa Monica, CA (US); Hyun Suk Song, Fullerton, CA (US); Ravi Sawhney, Calabasas, CA (US)

Correspondence Address: BRINKS HOFER GILSON & LIONE, P.O. BOX 10395, CHICAGO, IL, 60610, US

(21) Appl. No.: 11/434,555

(22) Filed: May 15, 2006

(51) Int. Cl. B26B 3/00

(52) U.S. Cl. 83/13; 30/314

(57) ABSTRACT

An adjustable food slicer is provided. The adjustable food slicer includes a handle having a grasping portion and a pair of side members extending from the grasping portion. A blade for slicing or planing vegetables, cheeses, or other sliceable food items, extends between the opposing side members. An adjustment mechanism is operatively connected to a spacer, wherein the adjustment mechanism and spacer are connected to the handle. The adjustment mechanism includes a rotatable dial that causes the spacer to move relative to the blade, thereby adjusting the distance between the spacer and blade for allowing the user to selectively adjust the thickness of the slice being removed.

### BACKGROUND

The present invention relates to food preparation, and in particular, to an adjustable food slicer.

Food slicers, or planers, are known in the art, and typically include a blade that is rigidly attached to a handle or a wire that extends between opposing legs. The blade is formed such that an aperture is formed between the blade and the handle. When the food slicer is used by the consumer, the consumer grasps the handle and moves the food slicer in a pulling movement over the piece of food such that a slice is cut by the blade and passed through the aperture formed between the blade or wire and the handle. The food slicer is typically used in slicing cheeses, vegetables, and other food items. Among the many variables that determine the thickness of the slice of food removed include the pressure that the consumer applies to the piece of food, the consistency of the food being sliced, the size of the aperture between the blade and the handle, and the angle at which the blade contacts the food. While this list of variables is not exhaustive, it is understood that it can be difficult to consistently remove slices of food from a brick or block such that each slice is substantially the same thickness. It is therefore desirable for a food slicer to provide for a slicing mechanism that produces slices having a substantially consistent thickness.

In addition, when used properly, conventional food slicers are adapted to slice food such that each slice has the same thickness. If a user desires to slice food at multiple thicknesses, multiple slicers may need to be purchased in order to produce the desired various thicknesses. It is therefore also desirable for a food slicer to be adjustable such that the thickness of the resulting slices can be determined by the user.

### BRIEF SUMMARY

According to a first aspect of the present invention, an adjustable food slicer is provided. The adjustable food slicer includes a handle having a blade operatively connected thereto. A spacer is also operatively connected to the handle, and the spacer is spaced apart from the blade. The handle further includes an adjustment mechanism attached thereto. The adjustment mechanism is also operatively attached to the spacer, and rotation of the adjustment mechanism selectively adjusts the distance between the spacer and the blade.

According to another aspect of the present invention, a method for adjusting a food slicer is provided. The method includes attaching a blade to a handle in a substantially rigid manner. The method further includes operatively connecting a spacer to the handle, wherein the spacer includes a contact surface spaced apart a distance from the blade. The method also includes rotating an adjustment mechanism for selectively changing the distance between the contact surface and the blade.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a top perspective view of a food slicer;

FIG. 2 is a bottom view of the food slicer of FIG. 1 with the cover removed;

FIG. 3 is a side view of an adjustment mechanism;

FIG. 4 is an exploded view of the food slicer of FIG. 1.

### DETAILED DESCRIPTION OF THE DRAWINGS AND THE PRESENTLY PREFERRED EMBODIMENTS

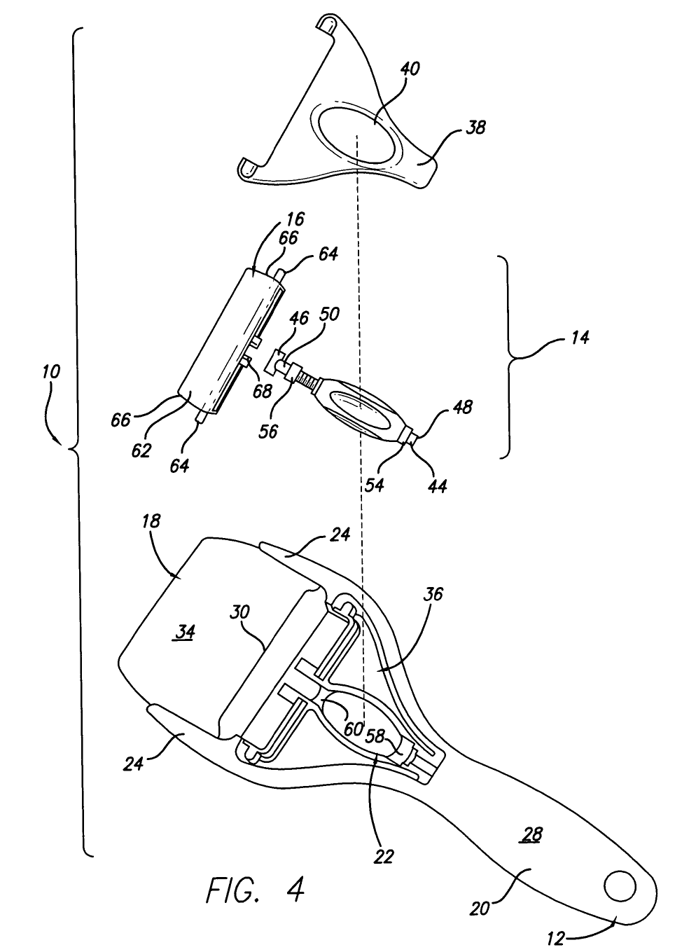

Referring to FIG. 1, an adjustable food slicer 10 is shown. The food slicer 10 can be used with various types of food including, but not limited to, cheese and vegetables. The food slicer 10 includes a handle 12, an adjustment mechanism 14, a spacer 16, and a blade 18. The handle 12 includes a graspable portion 20, an aperture 22 for receiving the adjustment mechanism 14, and a pair of opposing side members 24, as shown in FIGS. 1 and 4. The handle 12 further includes a top surface 26 and a bottom surface 28. The graspable portion 20 of the handle 12 allows a user to grip the handle 12 for use in slicing various types of food. The graspable portion 20 is shaped to provide an ergonomic gripping surface for a user. The graspable portion 20 is operatively connected to the opposing side members 24. In one embodiment, the opposing side members 24 are integrally formed with the graspable portion 20 to form a one-piece handle 12. In an alternative embodiment, the opposing side members 24 are attached to the graspable portion 20 by way an adhesive, screw, or other attachment mechanism sufficient to secure the opposing side members 24 to the graspable portion 20 in a substantially rigid manner. The handle 12 is preferably made of a plastic material, such as acrylonitrile-butadiene-styrene (ABS), but it should be understood by one skilled in the art that the handle 12 can be formed of any material sufficient to withstand the bending loads applied thereto during the operation of the food slicer 10.

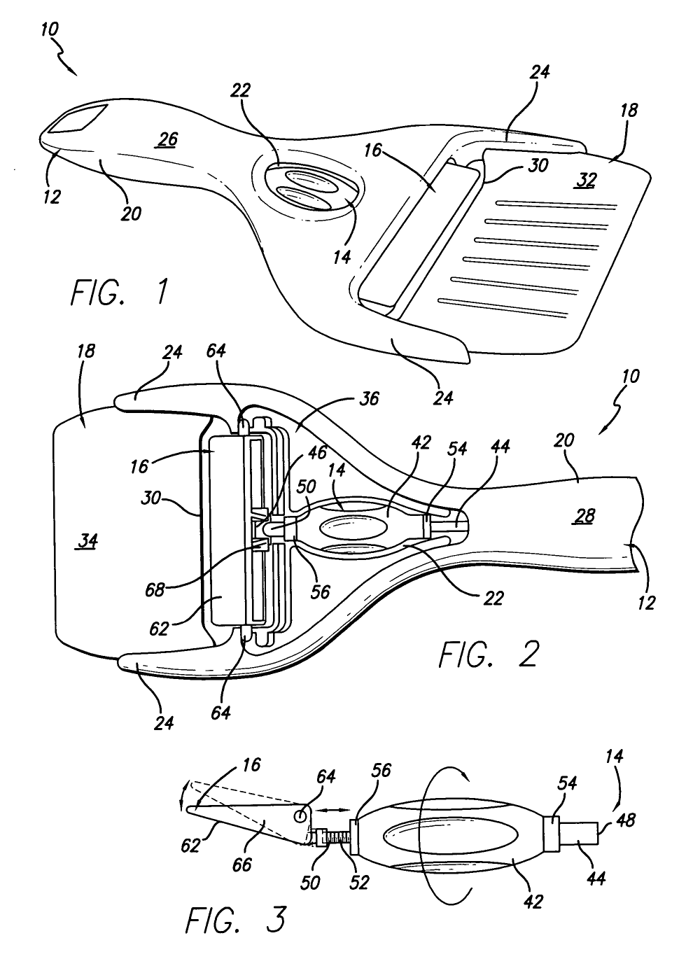

The blade 18 is operatively connected to the handle 12, wherein the blade 18 extends between the opposing side members 24, as shown in FIGS. 1-2. In one embodiment, the blade 18 is attached to the handle 12 in a substantially rigid manner. In an alternative embodiment, the blade 18 is integrally formed with the handle 12. The blade 18 can be formed of metal or any other material sufficient to provide a sharp cutting edge 30. The blade 18 can be made from the same material as the handle 12, or the material used to form the blade 18 can be different than the handle 12. The blade 18 includes the cutting edge 30, a top surface 32, and a bottom surface 34. The blade 18 is generally U-shaped between the opposing side members 24 such that the top surface of the blade 18 is lower than the junction at which the blade 18 attaches to the opposing side members 24.

The cutting edge 30 of the blade 18 is oriented in such a manner that the sharp edge is directed toward the graspable portion 20 of the handle 12, as shown in FIGS. 1-2. Because the blade 18 is generally U-shaped, the cutting edge 30 generally located below the bottom surface 28 of the handle 12 such that a pulling motion of the food slicer 10 by a user causes the cutting edge 30 to contact and remove a portion of food in a slicing manner.

An aperture 22 is formed through the thickness of the handle 12, as shown in FIGS. 1-2 and 4. The aperture 22 can be formed as a generally oval-like shape being elongated relative to the longitudinal length of the handle 12. It should be understood by one skilled in the art that the aperture 22 formed through the handle 12 can be any shape sufficient to receive a rotatable adjustment mechanism 14. The aperture 22 is adapted to receive the adjustment mechanism 14. The aperture 22 may, alternatively, be formed partially through the handle 12. The aperture 22 includes a detent 36 formed in the bottom surface 28 of the handle 12.

The adjustment mechanism 14 is disposed within the aperture 22 between the detent 36 in the bottom surface 28 and a cover 38 (FIG. 4). The cover 38 is attached to the handle 12 to secure the adjustment mechanism 14 within the aperture 22. The cover 38 is substantially the same shape as the detent 36 formed in the bottom surface 28 of the handle 12 to allow the cover 38 to fit within the detent 36 to form a substantially seamless bottom surface 28 of the handle 12 while securing the adjustment mechanism 14 within the handle 12. In the preferred embodiment, the cover 38 is received within the detent 36, and the cover 38 is attached to the handle 12 in a substantially rigid manner. In an alternative embodiment, the cover 38 is removably attached to the handle 12 to allow the cover 38 to be removed and replaced to provide the user access to the adjustment mechanism 14 for replacement or repair of the adjustment mechanism 14. The cover 38 includes an aperture 40 that correspond with the aperture 22 formed through the handle 12, and the aperture 40 of the cover 38 is also adapted to receive the adjustment mechanism 14.

The detent 36 formed in the bottom surface 28 of the handle 12 is adapted to receive the adjustment mechanism 14, as illustrated in FIGS. 2 and 4. The adjustment mechanism 14 includes a rotatable dial 42, an elongated pin 44, and a piston 46, as shown in FIGS. 2-4. The rotatable dial 42 is an elongated tubular member having a conduit (not shown) formed through the axial length of the dial 42. The conduit is adapted to receive the elongated pin 44 such that the pin 44 provides an axis of rotation about which the dial 42 is rotatable. The elongated pin 44 includes a first distal end 48 and a second distal end 50. At least a portion of the outer surface of the elongated pin 44 can have threads 52, and the inner surface of the conduit formed through the dial 42 includes threads (not shown) that correspond to the threads 52 on the outer surface of the pin 44. A first bearing 54 is disposed about the pin 44 and is located adjacent to the first distal end 48 of the pin 44, and the first bearing 54 is also located adjacent to one end of the dial 42. A second bearing 56 is disposed about the pin 44 and is located adjacent to the second distal end 50 of the pin 44, and the second bearing 56 is further located adjacent to the end of the dial 42 opposite the first bearing 54.

The detent 36 formed in the bottom surface 28 of the handle 12 includes a first receiving portion 58 located immediately adjacent to one end of the elongated aperture 22 and a second receiving portion 60 located immediately adjacent to the opposing end of the elongated aperture 22, as shown in FIG. 4. When the adjustment mechanism 14 is located within the detent 36 of the handle 12, the first receiving portion 58 is adapted to receive the first bearing 54 disposed about the pin 44, and the second receiving portion 60 is adapted to receive the second bearing 56 disposed about the pin 44. The first and second bearings 54, 56 are adapted to be in an abutting relationship with the opposing ends of the dial 42. Installation of the cover 38 within the detent 36 secures the first and second bearings 54, 56 relative to the first and second receiving portions 58, 60. The first and second bearings 54, 56 are in an abutting relationship with the opposing ends of the dial 42 such that the installation of the cover 38 secures the first and second bearings 54, 56 relative to the handle 12, thereby securing the dial 42 between the first and second receiving portions 58, 60 in a substantially fixed position within the aperture 22 formed through the handle 12.

Rotation of the dial 42 causes the threads formed on the inner surface of the conduit through the dial 42 to mesh with the threads 52 formed on the outer surface of the pin 44. Because the dial 42 is substantially fixed relative to the handle 12 and the piston 46 prevents the pin 44 from rotating about the longitudinal axis, the rotation of the dial 42 and meshing of the threads between the dial 42 and the pin 44 results in the pin translating in an axial direction through the dial 42, as illustrated in FIG. 3. Rotation of the dial 42 results in translation of the threaded pin 44.

In the preferred embodiment, the piston 46 is an elongated cylindrical member that is rigidly attached to the second distal end 50 of the pin 44, as illustrated in FIG. 4. The piston 46 is connected to the pin 44 in a transverse manner relative to the axial length of the pin 44. When the adjustment mechanism 14 is assembled within the aperture 22 and detent 36, the piston 46 is located adjacent to the side of the second receiving portion 60 opposite the dial 42. The piston 46 is operatively connected to the spacer 16 such that the adjustable mechanism 14 is adapted to adjust the position of the spacer 16 relative to the cutting edge 30 of the blade 18.

The spacer 16 is an elongated member having a generally triangular cross-section, as shown in FIG. 3. The spacer 16 is operatively connected to the handle 12 and the position of the spacer 16 relative to the cutting edge 30 is adjustable by the adjustment mechanism 14. The spacer 16 includes a contact surface 62 that is adapted to contact the piece of food as the food slicer 10 is used. As illustrated in FIGS. 2-4, a pin 64 extends from each of the opposing end surfaces 66 of the spacer 16. The pins 64 are aligned through the length of the spacer 16, thereby providing an axis about which the spacer 16 can rotate. The pins 64 extend laterally from the opposing end surface 66 at a position adjacent to corresponding corners of the end surfaces 66. The pins 64 are aligned at a position offset from the axial centerline of the spacer 16 such that the spacer 16 rotates about the axis generated by the pins 64 in an eccentric manner, as illustrated in FIG. 3.

The spacer 16 also includes a groove 68 that is adapted to receive the piston 46 which is fixedly attached to the pin 44 of the adjustment mechanism 14, as illustrated in FIGS. 2-4. The groove 68 is oriented in a substantially parallel manner with the longitudinal length of the spacer 16. The groove 68 is disposed adjacent to an edge of the spacer 16 such that the elongated length of the groove 68 is substantially parallel to, and spaced apart from, the axis generated by the aligned pins 64. The groove 68 can receive the piston 46 such that the piston 46 is secured to the spacer 16 and is prevented from rotation about the axis of the pin 44 to which the piston 46 is attached.

The eccentric rotation of the spacer 16 results in the distance between the contact surface 62 of the spacer 16 relative to the cutting edge 30 of the blade 18 to be increased or decreased. The distance between the contact surface 62 of the spacer 16 and the cutting edge 30 of the blade 18 is selectively determined by the user of the food slicer 10 such that the increase or decrease of the space between the contact surface 62 and the cutting edge 30 allows for the thickness of the slice of food being removed to be increased or decreased accordingly.

When assembled, the pins 64 of the spacer 16 are disposed between the detent 36 of the handle 12 and the cover 38, as shown in FIG. 4. The cover 38 secures the pins 64 relative to the handle 12 and allows the pins 64 to rotate. Translational movement of the pin 44 as described above results in the translation of the piston 46 toward and away from the dial 42, wherein the translational movement of piston 46 further results in the rotation of the spacer 16 about the laterally-extending pins 62 of the spacer such that the distance between the contact surface 62 of the spacer 16 and the cutting edge 30 is selectively increased or decreased by the user. Once the desired distance between the contact surface 62 and the cutting edge 30 is obtained the user discontinues rotation of the dial 42. The meshing relationship between the threads on the pin 44 and the threads within the conduit of the dial 42 maintain the positional relationship between the pin 44 and the dial 42.

The adjustment mechanism 14 adjusts the relative position of the spacer 16 by way of selective rotation of the dial 42. The adjustment mechanism 14 provides for efficient adjustment of the spacer 16 relative to the blade 18 by way of rotational movement of the dial 42. The selective position of the spacer 16 relative to the blade 18 is adjustable in a single manual step consisting of rotation of the dial 42, thereby providing the adjustable food slicer 10 with a single-movement operation to selectively determine the thickness of a slice of food being removed. The single-movement operation includes the rotation of the dial 42 of the adjustment mechanism 14, wherein the rotation of the dial 42 selectively positions the contact surface 62 of the spacer 16 relative to the cutting edge 30 of the blade 18. The dial 42 is rotatable about an axis that is transverse to the rotational axis of the spacer 16, wherein rotation of the dial 42 is converted into translation of the pin 44 by way of the threaded engagement between the pin 44 and the dial and the translational movement of the pin 44 is converted into rotational movement of the spacer 16 about the aligned pins 64 of the spacer 16. In an alternative embodiment, the dial 42 is operatively connected to a cam (not shown) that is configured to cause the spacer 16 to rotate as the dial 42 is rotated. In yet another alternative embodiment, the dial 42 is operatively connected to a spring (not shown) that is configured to cause the spacer 16 to rotate as the dial 42 is rotated. It should be understood by one skilled in the art that any mechanism sufficient to cause the spacer 16 to rotate about the pins 64 that extend from the side surfaces 66 of the spacer as a result of the rotation of the dial 42 can be used.

While preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

1. An adjustable food slicer comprising:
a handle having a blade operatively connected thereto;
a spacer operatively connected to said handle, wherein said spacer is spaced apart from said blade a distance; and
an adjustment mechanism operatively attached to said handle and to said spacer, wherein said adjustment mechanism selectively adjusts said distance between said spacer and said blade.

2. The adjustable food slicer of claim 1, wherein said adjustment mechanism includes a rotatable dial.

3. The adjustable food slicer of claim 2, wherein rotation of said dial selectively adjusts said distance between said spacer and said blade.

4. The adjustable food slicer of claim 1, wherein said spacer is rotatable about a first axis and said dial is rotatable about a second axis which is oriented in a substantially transverse manner relative to said first axis.

5. The adjustable food slicer of claim 1, wherein said adjustment mechanism includes a dial threadably connected to an elongated pin.

6. The adjustable food slicer of claim 5, wherein said dial includes a conduit that receives said pin, said conduit having an axial length and rotation of said dial causes said elongated pin to translate along said axial length.

7. The adjustable food slicer of claim 6, wherein said conduit has an inner surface that is threaded and said elongated pin has a an outer surface that is threaded, said threaded surfaces are meshingly engaged.

8. The adjustable food slicer of claim 6, wherein translation of said elongated pin along said axial length causes said spacer to rotate such that said distance between said contact surface and said blade is adjustable.

9. The adjustable food slicer of claim 8, wherein said spacer rotates about an axis that is substantially transverse relative to an axis about which said dial rotates.

10. The adjustable food slicer of claim 1, wherein said spacer is rotatable relative to said handle.

11. The adjustable food slicer of claim 10, wherein said spacer rotates in an eccentric manner.

12. The adjustable food slicer of claim 10, wherein said spacer includes a pair of pins extending from opposing side surfaces of said spacer, and said pair of pins are receiving by said handle.

13. The adjustable food slicer of claim 1, wherein adjustment of said distance between said contact surface and said blade can be accomplished by a single-movement operation of said adjustment mechanism.

14. A method for adjusting a food slicer comprising:
attaching a blade to a handle in a substantially rigid manner;
operatively connecting a spacer to said handle, wherein said spacer includes a contact surface spaced apart a distance from said blade; and
rotating an adjustment mechanism for selectively changing said distance between said contact surface and said blade.

15. The method of claim 14, wherein rotation of said adjustment mechanism can be done as a single-movement operation.

16. The method of claim 14, wherein said adjustment mechanism includes a rotatable dial that is operatively connected to said spacer, and rotation of said dial causes said spacer to rotate.

17. The method of claim 16, wherein said dial is rotatable about an axis that is substantially transverse to an axis about which said spacer is rotatable.

18. The method of claim 14, wherein rotation of said spacer allows said distance between said contact surface and said blade to be selectively changeable.

19. The method of claim 18, wherein said spacer is rotatable in an eccentric manner.

20. A food slicer comprising:
a movable spacer;
a blade operatively attached to said spacer, said blade being spaced apart from said spacer; and
an adjustment mechanism operable to move said spacer relative to said blade, wherein said adjustment mechanism is operable by a single-movement operation.

21. A method of slicing food, said method comprising the steps of:
providing a slicer having a blade and a spacer spaced-apart from said blade a distance;
adjusting said distance between said spacer and said blade by an adjustment mechanism having a single-movement operation; and
sliding said slicer over a piece of food such that a piece of food is removed by said blade.

22. The method of claim 21, wherein said adjustment mechanism includes a dial that is operatively connected to said spacer.

23. The method of claim 22, wherein rotation of said dial causes said spacer to rotate such that said distance between said spacer and said blade is changed.
